(19) United States
(12) Patent Application Publication
(10) Pub. No.: US 2026/0268769 A1
(43) Pub. Date: Sep. 10, 2026

(54) VEHICLE CONTROL DEVICE AND VEHICLE CONTROL METHOD

(71) Applicant: Astemo, Ltd., Chiyoda-ku, Tokyo (JP)

(72) Inventors: Yoshinobu OGASAWARA, Hitachinaka-shi, Ibaraki (JP); Shigenori HAYASE, Hitachinaka-shi, Ibaraki (JP); Tatsuhiko MONJI, Hitachinaka-shi, Ibaraki (JP)

(73) Assignee: Astemo, Ltd., Chiyoda-ku, Tokyo (JP)

(21) Appl. No.: 19/166,169

(22) PCT Filed: Jun. 20, 2023
(86) PCT No.: PCT/JP2023/022770

§ 371 Date: Sep. 17, 2025

(51) Int. Cl. G08G 1/0968; G01C 21/00; G01C 21/34; G08G 1/16

(52) U.S. Cl. CPC G08G 1/096833; G01C 21/3461; G01C 21/3859; G01C 21/3885; G08G 1/16

(57) ABSTRACT

A vehicle control device includes a recognition unit configured to recognize external world information of a periphery of an own vehicle and detect an evacuation candidate area for evacuating the own vehicle that passes by an oncoming vehicle, an availability determination unit configured to determine availability of the evacuation candidate area detected by the recognition unit, and an evacuation area setting unit configured to set the evacuation candidate area determined as usable by the availability determination unit as an evacuation area.

### TECHNICAL FIELD

The present invention relates to a vehicle control device and a vehicle control method.

### BACKGROUND ART

Conventionally, an assistance system that assists passing through a road where passing by of vehicles is difficult is known (e.g., PTL 1).

PTL 1 describes that “a vehicle determines whether or not to pass by other vehicles based on a state of the periphery of the vehicle, information related to sizes of vehicle bodies of the other vehicles, and a size of the vehicle body of the vehicle. In addition, when it is determined that the passing by with other vehicles is not possible, the vehicle searches for a first evacuation candidate area to where the vehicle can evacuate based on the state of the periphery of the vehicle detected along the traveling locus of the vehicle by the detection device”.

### CITATION LIST

### Patent Literature

PTL 1: JP 2022-119106 A

### SUMMARY OF INVENTION

### Technical Problem

As described above, when it is difficult for oncoming vehicles to pass by each other, an evacuation candidate area to where the vehicle can evacuate is searched for based on the state of the periphery of the vehicle. However, since the technology described in PTL 1 searches for an evacuation candidate area based only on the size of the vehicle body of the vehicle and the empty space information of the periphery, there is a possibility that the searched evacuation candidate area is not appropriate as an evacuation place such as a private land or no entry.

The present invention has been made in view of such a situation, and an object of the present invention is to select an appropriate evacuation place on a road where it is difficult to pass by an oncoming vehicle.

### Solution to Problem

The present invention includes a recognition unit configured to recognize external world information of the periphery of an own vehicle and detect an evacuation candidate area for evacuating the own vehicle that passes by an oncoming vehicle, an availability determination unit configured to determine availability of the evacuation candidate area detected by the recognition unit, and an evacuation area setting unit configured to set the evacuation candidate area determined as usable by the availability determination unit as an evacuation area.

### Advantageous Effects of Invention

According to the present invention having the above configuration, an appropriate evacuation place can be selected on a road where it is difficult to pass by an oncoming vehicle.

### BRIEF DESCRIPTION OF DRAWINGS

FIG. 1 is a block diagram illustrating a configuration example of a vehicle system according to a first embodiment of the present invention.

FIG. 2 is a diagram for explaining a passing-by operation of oncoming vehicles.

FIG. 3 is a diagram illustrating a data configuration example of an availability determination table in the vehicle control device according to the first embodiment of the present invention.

FIG. 4 is a diagram illustrating a specific example of an external environment detected in the vehicle control device according to the first embodiment of the present invention.

FIG. 5 is a flowchart illustrating a procedure of a vehicle control processing in the vehicle control device according to the first embodiment of the present invention.

FIG. 6 is a block diagram illustrating a hardware configuration example of the vehicle control device according to the first embodiment of the present invention.

FIG. 7 is a block diagram illustrating a configuration example of a vehicle system according to a second embodiment of the present invention.

FIG. 8 is a diagram illustrating a data configuration example of an availability determination table in the vehicle control device according to the third embodiment of the present invention.

### DESCRIPTION OF EMBODIMENTS

Hereinafter, embodiments of the present invention will be described with reference to the accompanying drawings. In the present specification and the drawings, components having substantially the same function or configuration are denoted by the same reference numerals, and redundant description will be omitted. The present invention is applicable to, for example, an arithmetic device for vehicle control with which an Advanced Driver Assistance System (ADAS) or an in-vehicle Electronic Control Unit (ECU) for Autonomous Driving (AD) can communicate.

### First Embodiment

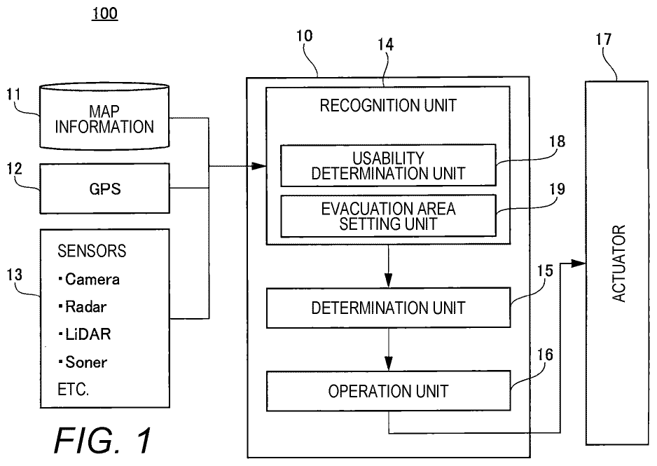

First, a configuration of a vehicle system according to a first embodiment of the present invention will be described. FIG. 1 is a block diagram illustrating a configuration example of a vehicle system 100 according to the present embodiment. As illustrated in FIG. 1, the vehicle system 100 includes a vehicle control device 10, map information 11, a Global Positioning Satellite (GPS) 12, sensors 13, and an actuator 17. The map information 11, the GPS 12, and the sensors 13 are each connected to the vehicle control device 10. The vehicle control device 10 is further connected to the actuator 17. Note that in FIG. 1, only components related to the vehicle system 100 and the vehicle control device 10 according to the present embodiment are illustrated, and illustration and description of other components are omitted.

The map information 11 is, for example, a Standard (SD) map widely prepared on general a high-precision peripheral map generated in advance, a map (self-generated map) generated from measurement results of the sensors 13, or the like. Here, it is assumed that the map information 11 is registered in the vehicle control device 10 in advance. However, the present invention is not limited thereto, and the map information 11 may be acquired from the outside (see second embodiment described later). The map information 11 includes at least land information indicating what kind of land the empty area is, for example, information such as a private land, a road shoulder, a parking lot of an individual's house, and a store land. Note that the land information of the empty area is not limited to the above information, and may include other information.

The GPS 12 detects position coordinates of the own vehicle and outputs the position coordinates to the vehicle control device 10.

The sensors 13 are an exterior camera (Camera), a millimeter wave radar (Radar), a lidar (LiDAR), an ultrasonic sensor (Soner), or the like that can detect external world information including object information around the vehicle, travelable area information, and the like. Note that the sensors 13 are not limited to the various devices described above, and may be any device as long as the device can detect external world information around the vehicle. Furthermore, here, the object information around the vehicle includes, for example, a pedestrian, a moving object such as another vehicle, a traffic signal, a road mark, a lane marking, a stationary object such as a pylon, and the like.

The actuator 17 is a driving device that changes an advancing direction, an advancing speed, and the like of the vehicle by driving an accelerator, a brake, a steering, and the like of the vehicle.

### [Vehicle Control Device]

As illustrated in FIG. 1, the vehicle control device 10 includes a recognition unit 14, a determination unit 15, and an operation unit 16. The recognition unit 14, the determination unit 15, and the operation unit 16 are connected in this order. The recognition unit 14 acquires the map information 11, the GPS 12, and the output information of the sensors 13, detects a traveling place, a travelable area, and the like based on the acquired information, and outputs the detected place, area and the like to the determination unit 15. In addition, the recognition unit (recognition unit 14) recognizes external world information of the periphery of the own vehicle based on the acquired map information 11, the GPS 12, and the output information of the sensors 13, and detects an evacuation candidate area for evacuating the own vehicle that passes by the oncoming vehicle. The evacuation candidate area is an empty area other than a road adjacent to the road on which own vehicle travels. Here, the empty area includes a land of a certain segment where the own vehicle can stop. In addition, the land of the certain segment includes a sidewalk adjacent to the road, land of a building adjacent to the road, a private land adjacent to the road, and the like.

As illustrated in FIG. 1, the recognition unit 14 includes an availability determination unit 18 and an evacuation area setting unit 19. Note that, in the configuration example illustrated in FIG. 1, the availability determination unit 18 and the evacuation area setting unit 19 are internal configurations of the recognition unit 14, but the present invention is not limited thereto. The availability determination unit 18 and the evacuation area setting unit 19 may be external configurations of the recognition unit 14.

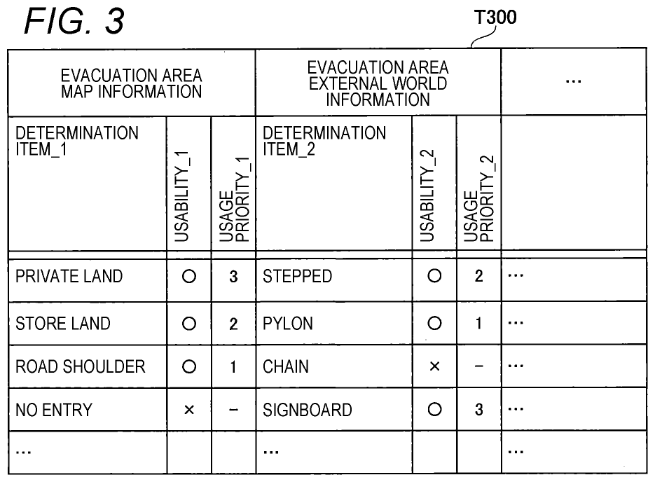

The availability determination unit (availability determination unit 18) determines availability of the evacuation candidate area detected by the recognition unit (recognition unit 14) based on at least one of the map information 11 registered in advance and the external world information recognized by the recognition unit 14. In addition, in a case where there are a plurality of evacuation candidate areas, the availability determination unit (availability determination unit 18) determines availability of the evacuation candidate area based on usage priority corresponding to each piece of feature information of the plurality of evacuation candidate areas set in advance. Here, the feature information of the evacuation candidate area is a determination item in an availability determination table T300 to be described later (see FIG. 3 to be described later). The feature information of the evacuation candidate area includes at least one of land information of the evacuation candidate area (see “determination item_1” in FIG. 3 to be described later) and information regarding an obstacle installed in the evacuation candidate area (see “determination item_2” in FIG. 3 to be described later). In addition, the information regarding the obstacle includes information regarding a sign indicating entry availability to the evacuation candidate area is possible and information regarding an obstacle for preventing entry into the evacuation candidate area.

The evacuation area setting unit (evacuation area setting unit 19) sets an evacuation candidate area determined by the availability determination unit 18 as an evacuation area, and outputs information of the set evacuation area to the determination unit 15.

The determination unit 15 acquires information such as an own vehicle position, a traveling place, and a travelable area from the recognition unit 14, determines a movement such as acceleration or deceleration of the own vehicle based on the acquired various information, and outputs a determination result to the operation unit 16. In addition, the determination unit 15 determines the traveling direction, the traveling speed, and the like of the own vehicle so as to advance to the evacuation area based on the information of the evacuation area set by the evacuation area setting unit 19, and outputs the determination result to the operation unit 16.

The operation unit 16 outputs an instruction to drive the accelerator, the brake, the steering, and the like of the vehicle to the actuator 17 based on the determination result of the traveling direction, the traveling speed, the acceleration, the deceleration, and the like of the own vehicle determined by the determination unit 15. The actuator 17 is operated by an instruction from the operation unit 16.

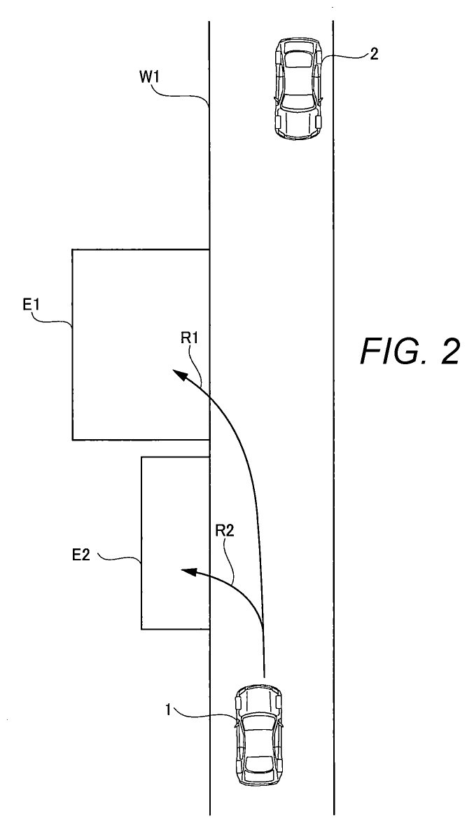

Next, the passing-by operation of the oncoming vehicles will be described. FIG. 2 is a diagram for explaining a passing-by operation of the oncoming vehicles. The vehicle 1 and the vehicle 2 illustrated in FIG. 2 are vehicles traveling on the same road W1 in opposite directions. The area E1 and the area E2 are empty areas adjacent to the road W1. In the present embodiment, “passing by” means that the vehicle 1 and the vehicle 2 pass by each other, and does not include traveling in the same direction, for example, overtaking another vehicle ahead.

In the case of the passing-by illustrated in FIG. 2, the recognition unit 14 of the vehicle control device 10 included in the vehicle 1 detects the area E1 and the area E2 as the evacuation candidate areas. In addition, the availability determination unit 18 of the recognition unit 14 determines whether or not the area E1 and the area E2 can be used. The availability determination unit 18 determines which one of the area E1 and the area E2 is to be used based on the feature information of each of the area E1 and the area E2 and the usage priority corresponding to the feature information, and outputs the determination result to the evacuation area setting unit 19. The evacuation area setting unit 19 sets the evacuation area based on the determination result of the availability determination unit 18 and outputs information of the evacuation area to the determination unit 15. Then, the determination unit 15 determines a route (e.g., the route R1 and the route R2 in the drawing) from the current position of the vehicle 1 to the evacuation area, a traveling speed, and the like, and outputs a determination result to the operation unit 16. The operation unit 16 controls the actuator 17 based on the determination result of the determination unit 15 so as to cause the vehicle 1 to evacuate to the area E1 or the area E2 using the route R1 or the route R2.

Note that the areas E1 and E2 that are the evacuation candidate areas illustrated in FIG. 2 are quadrangular empty areas on the left side of the road W1 along the traveling direction of the vehicle 1, but the present invention is not limited thereto. The evacuation candidate area may be either the left side or the right side of the road on which the vehicle travels. In addition, the shape of the evacuation candidate area is not limited to a quadrangle, and may be any shape. In addition, the evacuation candidate area is an area where the vehicle can be temporarily or permanently stopped, for example, a parking lot of an individual's home, a store parking lot, a roadside zone, a sidewalk, or the like. However, the evacuation candidate area is not limited to a parking lot of an individual's home, a store parking lot, a roadside zone, a sidewalk, or the like.

Next, a data configuration example of the availability determination table in the vehicle control device 10 will be described. FIG. 3 is a diagram illustrating a data configuration example of the availability determination table in the vehicle control device 10 according to the present embodiment.

As illustrated in FIG. 3, the availability determination table T300 includes “evacuation area map information” and “evacuation area external world information”. The “evacuation area map information” is static information for determining an evacuation candidate area based on the map information 11, and includes fields of “determination item_1”, “availability_1”, and “usage priority_1”. The “evacuation area external world information” is dynamic information for determining an evacuation candidate area based on the detection information of the sensors 13, and includes fields of “determination item_2”, “availability_2”, and “usage priority_2”. Note that the configuration of the availability determination table T300 is not limited to the above configuration, and may include information other than “evacuation area map information” and “evacuation area external world information”, for example, size information of an evacuation candidate area, and the like.

The “determination item_1” of the “evacuation area map information” stores land information of an empty area included in the map information 11, that is, land information of an evacuation candidate area, for example, information such as “private land”, “store land”, “road shoulder”, and “no entry”. Note that the land information is not limited to the respective pieces of information described above, and may include arbitrary information as long as the information indicates what kind of land the evacuation candidate area is.

In the “availability_1” of the “evacuation area map information”, information indicating whether or not an evacuation candidate area having the land information stored in the “determination item_1” is usable is stored. For example, in a case where the evacuation candidate area having the land information stored in the “determination item_1” is usable, “o” is stored. In a case where the evacuation candidate area having the land information stored in the “determination item_1” is non-usable, “x” is stored. Note that the information stored in “availability_1” is not limited to “o” and “x”, and may be arbitrary information as long as the information can indicate availability of the evacuation candidate area.

In the “usage priority_1” of the “evacuation area map information”, the usage priority corresponding to the land information stored in the “determination item_1”, for example, information such as “1”, “2”, “3”, and “-” is stored. Here, it is assumed that a smaller value stored in “usage priority_1” has a higher priority, but the present invention is not limited thereto, and a larger value stored in “usage priority_1” may have a higher priority. “-” is a value of “usage priority_1” corresponding to the non-usable land information (“availability_1” is “x”). Note that the information stored in “usage priority_1” is not limited to numerical values such as “1”, “2”, and “3”, and may be arbitrary information as long as the information can represent priority.

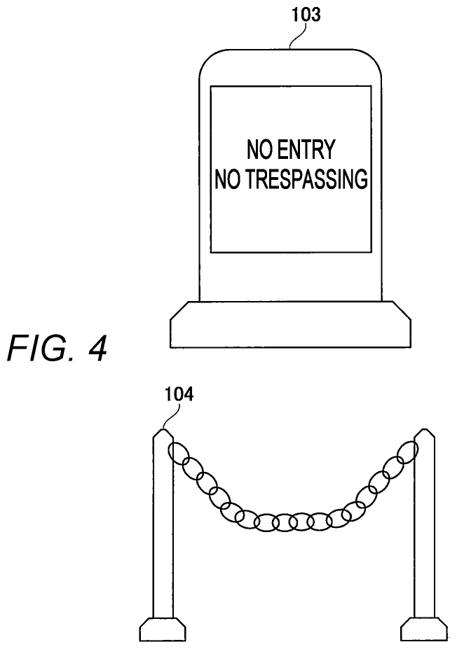

In the “determination item_2” of the “evacuation area external world information”, external world information (see FIG. 4 to be described later) of the periphery of the own vehicle detected by the sensors 13, for example, information such as “stepped”, “pylon”, “chain”, and “signboard” is stored. Note that the “determination item_2” is not limited to the above-described information, and may include arbitrary information as long as the information is external world information of the periphery of the own vehicle detected by the sensors 13.

In the “availability_2” of the “evacuation area external world information”, information indicating whether or not an evacuation candidate area having the external world information stored in the “determination item_2” is usable is stored. For example, in a case where the evacuation candidate area having the external world information stored in the “determination item_2” is usable, “o” is stored. In a case where the evacuation candidate area having the external world information stored in the “determination item_2” is non-usable, “x” is stored. Note that the information stored in “availability_2” is not limited to “o” and “x”, and may be arbitrary information as long as the information can indicate availability of the evacuation candidate area.

In the “usage priority_2” of the “evacuation area map information”, the usage priority corresponding to the external world information stored in the “determination item_2”, for example, information such as “1”, “2”, “3”, and “-” is stored. Note that the “usage priority_2” is similar to the “usage priority_1”, and thus redundant description will be omitted.

Note that an example in which the above-described “evacuation area map information” and the “evacuation area external world information” have the “usage priority_1” and the “usage priority_2”, respectively, has been described, but the present invention is not limited thereto. One usage priority, for example, a usage priority obtained by integrating the “usage priority_1” and the “usage priority_2” may be provided for the “evacuation area map information” and the “evacuation area external world information”.

In the present embodiment, the availability determination unit 18 of the recognition unit 14 first determines the land information of the evacuation candidate area, and determines whether or not the evacuation candidate area is usable based on the “determination item_1” and the “availability_1” of the availability determination table T300. When the “availability_1” corresponding to the land information of the evacuation candidate area is “o”, the availability determination unit 18 determines that the evacuation candidate area is usable. Next, in a case where there are a plurality of determined evacuation candidate areas, the availability determination unit 18 determines the priority of the plurality of evacuation candidate areas based on the “usage priority_1” of the availability determination table T300.

Here, in a case where the vehicle does not include the sensors 13, the availability determination unit 18 selects an evacuation candidate area having the highest usage priority based on the “usage priority_1”. On the other hand, in a case where the vehicle includes the sensors 13, the availability determination unit 18 determines the priority order of the plurality of evacuation candidate areas based on the “usage priority_1”, and then further determines whether or not the evacuation candidate area is usable based on dynamic information (“evacuation area external world information”). The availability determination unit 18 determines whether or not the evacuation candidate area is usable based on the external world information detected by the sensors 13 and the “determination item_2” and the “availability_2” of the availability determination table T300. In a case where the “availability_2” corresponding to the external world information of the vehicle is “o”, the availability determination unit 18 determines that the evacuation candidate area is usable. Next, in a case where there are a plurality of determined evacuation candidate areas, the availability determination unit 18 selects the evacuation candidate area having the highest usage priority based on the “usage priority_2” of the availability determination table T300.

In addition, for example, in a case where the vehicle does not include the map information 11 and includes only the sensors 13, the availability determination unit 18 may perform the determination processing of the evacuation candidate area based only on the dynamic information (“evacuation area external world information”).

By using the availability determination table T300, the determination as to whether or not the evacuation candidate area is appropriate is automatically executed by the vehicle control device 10, the driver's operation becomes unnecessary, and the waiting time by the driver's operation is eliminated. Therefore, it is possible to prevent a situation in which vehicles face each other and there is only a method of having one of them travel backward, and the pass-by action can be smoothly carried out. In addition, by using the availability determination table T300, it is possible to determine the availability in various scenes and not only the single item determination. In addition, by providing the item of the usage priority, even in a case where a plurality of evacuation candidate areas are detected, it is possible to perform the pass-by action using the optimal evacuation place. For example, when three locations of a private land, a store land, and a road shoulder are detected as a plurality of evacuation candidate areas, the usage determination is made as a land other than the private land with only the single item determination. However, by using the availability determination table T300, the road shoulder having the highest usage priority is selected as the optimum evacuation area, and it is possible to select the optimum area as the evacuation place in the pass-by action.

FIG. 4 is a diagram illustrating a specific example of the external environment detected by the sensors 13 included in the vehicle. In FIG. 4, as a specific example of the external environment, a signboard 103 and a chain 104 indicating “no entry no trespassing” are illustrated.

### [Procedure of Vehicle Control Processing]

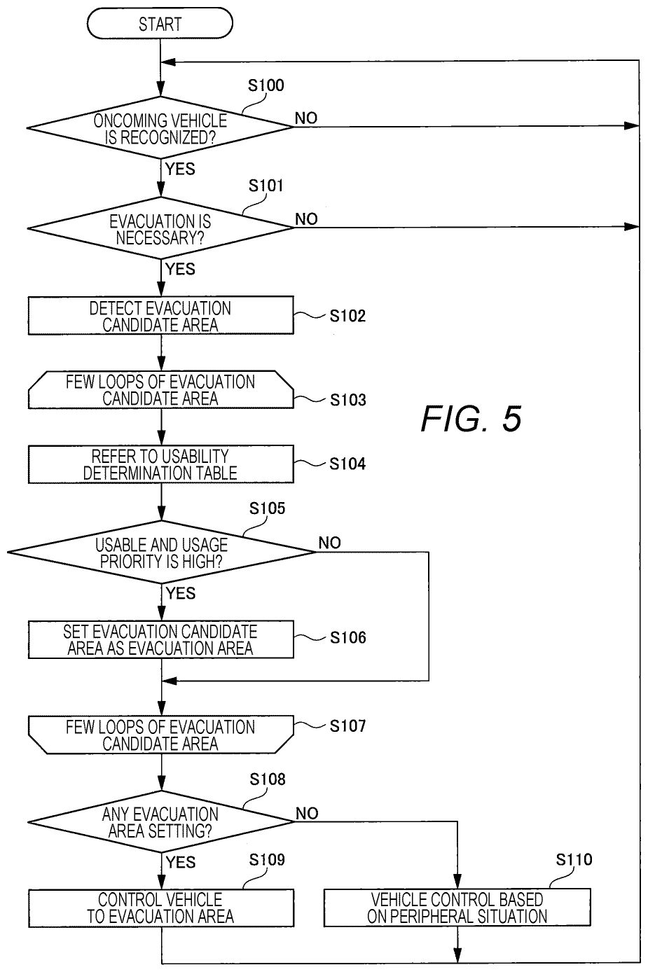

Next, a procedure of a vehicle control processing in the vehicle control device 10 will be described. FIG. 5 is a flowchart illustrating a procedure of a vehicle control processing in the vehicle control device 10 according to the present embodiment. The processing described below is started by the vehicle control device 10 periodically or at a predetermined timing and is repeatedly executed.

First, the recognition unit 14 determines whether or not an oncoming vehicle has been recognized (step S100).

When determining that the oncoming vehicle has not been recognized in the processing of step S100 (NO determination in step S100), the recognition unit 14 repeatedly executes the processing of step S100.

On the other hand, when determining that the oncoming vehicle has been recognized in the processing of step S100 (YES determination in step S100), the recognition unit 14 determines whether or not the own vehicle needs to be evacuated (step S101). In this processing, when determining that passing by with the oncoming vehicle is possible based on the vehicle body size of the own vehicle, the vehicle body size of the recognized oncoming vehicle, and the width of the road, the recognition unit 14 determines that the own vehicle does not need to be evacuated, and NO determination is made in step S101. On the other hand, when determining that passing by with the oncoming vehicle is not possible based on the vehicle body size of the own vehicle, the vehicle body size of the detected oncoming vehicle, and the width of the road, the recognition unit 14 determines that the own vehicle needs to be evacuated, and YES determination is made in step S101.

When determining that there is no need for evacuation in the processing of step S101 (NO determination in step S101), the recognition unit 14 returns to the processing of step S100 and repeatedly executes the processing of steps S100 to S101.

On the other hand, when determining that there is need for evacuation in the processing of step S101 (YES determination in step S101), the recognition unit 14 detects an evacuation candidate area (step S102). In this processing, the recognition unit 14 detects an empty area around the vehicle based on the map information 11 and the peripheral information detected by the sensors 13 and sets the empty area as an evacuation candidate area.

Next, the recognition unit 14 executes processing (determination processing of the evacuation candidate area) of steps S103 to S107 (number of loops corresponding to the evacuation candidate areas) on each of the detected evacuation candidate areas. That is, the processing in steps S103 to S107 IS repeatedly executed several times for the detected evacuation candidate area.

In the processing of step S103, a number of loops corresponding to the evacuation candidate areas are started.

In the processing of step S104, the availability determination unit 18 of the recognition unit 14 refers to the availability determination table T300.

Next, in the processing of step S105, the availability determination unit 18 determines whether the evacuation candidate area is usable and the usage priority thereof is the highest among the plurality of evacuation candidate areas based on the availability determination table T300.

When the availability determination unit 18 determines that the evacuation candidate area is usable and the usage priority thereof is the highest among the plurality of evacuation candidate areas in the processing of step S105 (YES determination in step S105), the evacuation area setting unit 19 sets the evacuation candidate area as the evacuation area (step S106). In addition, in this processing, the evacuation area setting unit 19 outputs information of the set evacuation area to the determination unit 15.

When the availability determination unit 18 determines that the evacuation candidate area is not usable and the usage priority thereof is not the highest among the plurality of evacuation candidate areas in the processing of step S105 (NO determination in step S105) or after the processing of step S106, the determination processing of the next evacuation candidate area (processing included in the number of loops corresponding to the evacuation candidate areas) is executed.

After the determination processing of the evacuation candidate area is executed for all the evacuation candidate areas, the number of loops corresponding to the evacuation candidate areas are terminated (step S107).

Next, the determination unit 15 determines whether or not an evacuation area is set (step S108). In this processing, when the information of the evacuation area is input from the evacuation area setting unit 19, the determination unit 15 determines that the evacuation area is set, and YES determination is made in step S108. On the other hand, when the information of the evacuation area is not input from the evacuation area setting unit 19, the determination unit 15 determines that the evacuation area is not set, and NO determination is made in step S108.

When determining that the evacuation area is set in the processing of step S108 (YES determination in step S108), the determination unit 15 controls the vehicle to stop in the evacuation area (step S109). In this processing, the determination unit 15 determines a route from the current position of the vehicle to the evacuation area, a traveling speed, and the like based on the evacuation area set by the evacuation area setting unit 19, and outputs a determination result to the operation unit 16. The operation unit 16 controls the actuator 17 to stop in the evacuation area based on the determination result of the determination unit 15.

On the other hand, when determining that the evacuation area is not set in the processing of step S108 (NO determination in step S108), the determination unit 15 controls the vehicle based on the peripheral situation (step S110). In this processing, the determination unit 15 may perform control to move to the left side of the road and stop, or may perform control to move rearward and leave the road, for example, based on the peripheral situation.

After the processing of step S109 or step S110, the vehicle control processing returns to step 100.

Note that in a case where the vehicle is in automatic driving, the vehicle control device 10 controls the operation of the vehicle so as to evacuate to the set evacuation area. When the vehicle is not in automatic driving, the vehicle control device 10 presents information of the evacuation area set by the recognition unit 14 to the driver by displaying the information on a display panel installed in the own vehicle.

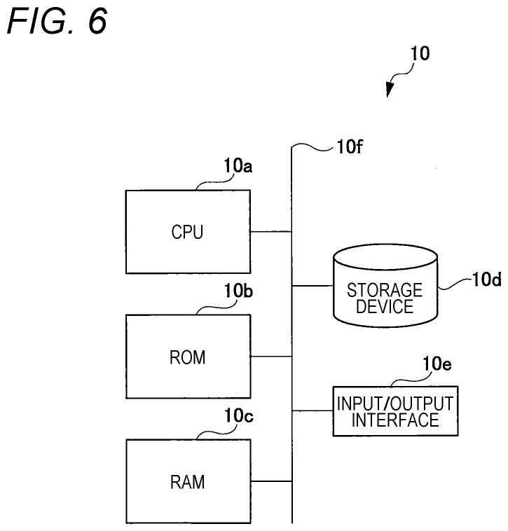

Next, a hardware configuration of the vehicle control device 10 will be described. FIG. 6 is a block diagram illustrating a hardware configuration example of the vehicle control device 10 according to the present embodiment. As illustrated in FIG. 6, the vehicle control device 10 includes a Central Processing Unit (CPU) 10a, a Read Only Memory (ROM) 10b, a Random Access Memory (RAM) 10c, a storage device 10d, and an input/output interface 10e in addition to the components illustrated in FIG. 1. The CPU 10a, the ROM 10b, the RAM 10c, the storage device 10d, and the input/output interface 10e are connected by a bus 10f so as to be able to transmit and receive information data to and from each other.

The CPU 10a controls the operation of each unit in the vehicle control device 10. For example, the CPU 10a controls the operation of each functional component of the vehicle control device 10 illustrated in FIG. 1. Specifically, for example, the CPU 10a controls the vehicle control processing illustrated in FIG. 5. Note that a Graphics Processing Unit (GPU) may be used instead of the CPU 10a, or the CPU 10a and the GPU may be used in combination.

The ROM 10b includes, for example, a storage medium such as a nonvolatile memory, and stores programs, data, and the like executed and referred to by the CPU 10a.

The RAM 10c includes, for example, a storage medium such as a volatile memory, and temporarily stores information (data) necessary for each processing performed by the CPU 10a.

The storage device 10d is constituted by a non-transitory computer-readable recording medium storing a program executed by the CPU 10a, and is constituted by a storage device such as a Hard Disk Drive (HDD). The storage device 10d stores a program for the CPU 10a to control each unit, an Operating System (OS), a controller program, and data. In addition, the storage device 10d stores the map information 11 and the like. Note that a part of the program and data stored in the storage device 10d may be stored in the ROM 10b. The non-transitory computer-readable recording medium storing the program executed by the CPU 10a is not limited to the HDD, and may be a recording medium such as a Solid State Drive (SSD), a Compact Disc (CD)-ROM, or a Digital Versatile Disc (DVD)-ROM.

The input/output interface 10e transmits/receives information data to/from the outside of the vehicle control device 10, for example, the GPS 12, the sensors 13, and the like illustrated in FIG. 1 under the control of the CPU 10a.

### [Effects]

As described above, when it is difficult for the own vehicle to pass by the oncoming vehicle, the vehicle control device 10 according to the present embodiment detects an evacuation candidate area around the own vehicle, selects an optimal evacuation candidate area based on the availability determination table T300, and sets the selected evacuation candidate area as an evacuation area. The availability determination table T300 includes static information (evacuation area map information) for determining the evacuation candidate area based on the map information 11, dynamic information (evacuation area external world information) for determining the evacuation candidate area based on the detection information of the sensors 13, and the usage priority of the evacuation candidate area. The vehicle control device 10 selects an evacuation candidate area that is usable and has the highest usage priority based on the information of the availability determination table T300 and sets the selected evacuation candidate area as an evacuation area. Therefore, according to the vehicle control device 10 of the present invention, an appropriate evacuation place can be selected on a road where it is difficult to pass by the oncoming vehicle.

### Second Embodiment

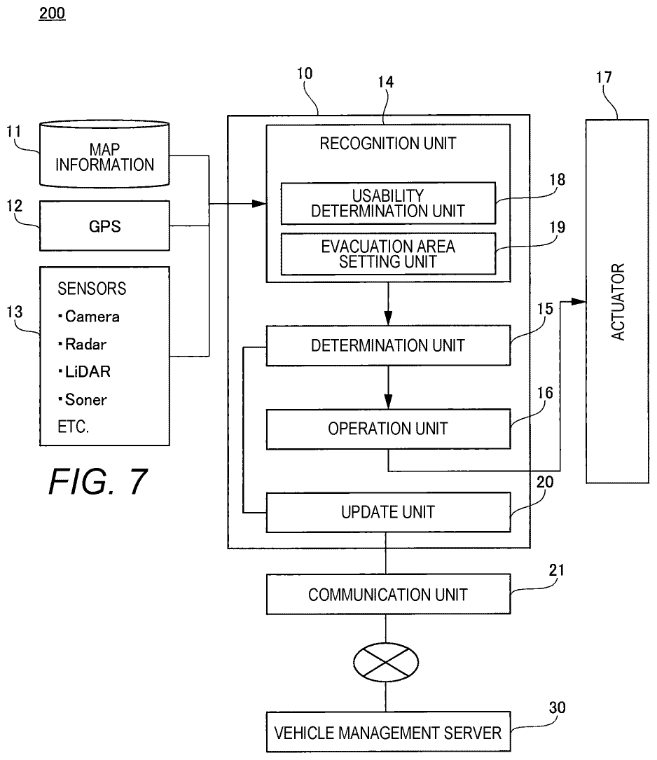

Here, a vehicle system 200 according to a second embodiment of the present invention will be described. FIG. 7 is a diagram illustrating a configuration example of the vehicle system 200 according to the present embodiment. As can be seen by comparing FIG. 7 with FIG. 1, the vehicle system 200 includes each component of the vehicle system 100 illustrated in FIG. 1, and further includes an update unit 20 and a communication unit 21.

The update unit 20 is installed inside the vehicle control device 10 and is connected to the determination unit 15. The update unit 20 is also connected to a communication unit 21 installed outside the vehicle control device 10. The update unit 20 inputs information of the evacuation area from the determination unit 15. In addition, the update unit (update unit 20) updates the map information 11 so that the information of the evacuation area is included in the map information 11 after the own vehicle has evacuated to the evacuation area set by the evacuation area setting unit (evacuation area setting unit 19). Furthermore, the update unit 20 outputs the updated map information 11 to the communication unit 21.

The communication unit 21 transmits the map information 11 updated by the update unit 20 to the vehicle management server 30 that manages the own vehicle via a wireless communication method or the like. The vehicle management server 30 manages the map information 11 including the information of the evacuation area received from the vehicle control devices 10 of all the vehicles to be managed. Furthermore, the communication unit 21 may acquire the map information 11 managed by the vehicle management server 30. The map information 11 acquired from the vehicle management server 30 also includes the usage record of the evacuation area of another vehicle. Therefore, when determining the evacuation candidate area based on the map information 11 acquired by the communication unit 21, the recognition unit 14 of the vehicle control device 10 can also refer to the usage record of the evacuation area of another vehicle.

Furthermore, the communication unit 21 can also acquire shared information or the like transmitted from another vehicle via, for example, Vehicle to X (V2X) communication. Note that the information received by the communication unit 21 from the outside is not limited to the above-described information, and arbitrary information may be received as long as the information can be used in the determination processing of the evacuation candidate area.

### [Effects]

As described above, in the vehicle system 200 according to the present embodiment, when setting the evacuation area, the vehicle control device 10 uses, in addition to the availability determination table T300, various types of information that are acquired from the outside by the communication unit 21 and can be used in the determination processing of the evacuation candidate area. By performing the determination processing of the evacuation candidate area using more information, the vehicle control device 10 of the vehicle system 200 according to the present embodiment can select an appropriate evacuation place with higher accuracy. In addition, since the vehicle control device 10 according to the present embodiment includes the update unit 20, it is also possible to transmit the map information 11 including the information of the evacuation area used by the own vehicle to the vehicle management server 30 and cooperate with another vehicle via the vehicle management server 30.

### Third Embodiment

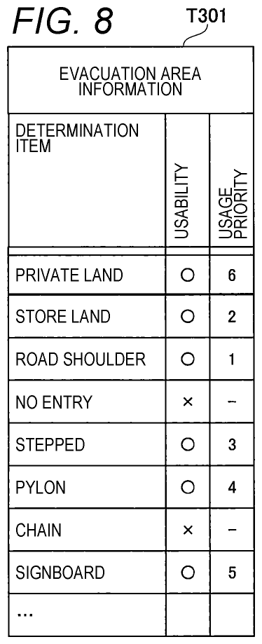

Here, a vehicle system according to a third embodiment of the present invention will be described. FIG. 8 is a diagram illustrating a data configuration example of the availability determination table T301 in the vehicle control device 10 of the vehicle system according to the present embodiment. As can be seen by comparing FIG. 8 and FIG. 3, in the present embodiment, the information of the availability determination table T301 is not divided into “evacuation area map information” and “evacuation area external world information”, and “evacuation area map information” and “evacuation area external world information” are collected in “evacuation area information”. That is, in the availability determination table T301 according to the present embodiment, static information and dynamic information coexist.

### [Effects]

In a case where the sensors 13 can detect the external environment information with high accuracy, the information of the map information 11 can be recognized by the sensors 13, and thus the vehicle control processing in the vehicle control device 10 can be executed at high speed by using the availability determination table T301 according to the present embodiment.

Note that the present invention is not limited to each embodiment described above, and it goes without saying that various other application examples and modified examples can be taken without departing from the gist of the present invention described in the claims.

For example, each of the above-described embodiments has specifically described in detail the configuration of the vehicle control device and the vehicle system in order to describe the present invention in an easy-to-understand manner, and is not necessarily limited to those having all the described configurations. In addition, a part of the configuration of the embodiment described here can be replaced with the configuration of another embodiment, and furthermore, the configuration of another embodiment can be added to the configuration of an embodiment. In addition, it is also possible to add, delete, and replace other configurations for a part of the configuration of each embodiment.

In addition, the control lines and the information lines indicate what is considered to be necessary for the description, and do not necessarily indicate all the control lines and the information lines on the product. In practice, it may be considered that almost all the configurations are connected to each other.

### REFERENCE SIGNS LIST

10 vehicle control device
11 map information
12 GPS
13 sensors
14 recognition unit
15 determination unit
16 operation unit
17 actuator
18 availability determination unit
19 evacuation area setting unit
20 update unit
21 communication unit
100, 200 vehicle system

1. A vehicle control device comprising:
a recognition unit configured to recognize external world information of a periphery of an own vehicle and detect an evacuation candidate area for evacuating the own vehicle that passes by an oncoming vehicle;
an availability determination unit configured to determine availability of the evacuation candidate area detected by the recognition unit; and
an evacuation area setting unit configured to set the evacuation candidate area determined as usable by the availability determination unit as an evacuation area.

2. The vehicle control device according to claim 1, wherein the availability determination unit determines availability of the evacuation candidate area based on at least one of map information registered in advance and the external world information recognized by the recognition unit.

3. The vehicle control device according to claim 2, Wherein in a case where there are a plurality of the evacuation candidate areas, the availability determination unit determines availability of the evacuation candidate area based on a usage priority corresponding to each piece of feature information of the plurality of evacuation candidate areas set in advance.

4. The vehicle control device according to claim 3, wherein the evacuation candidate area is an empty area other than a road adjacent to the road on which the own vehicle travels.

5. The vehicle control device according to claim 4, wherein the feature information includes at least one of land information of the evacuation candidate area and information regarding an obstacle installed in the evacuation candidate area.

6. The vehicle control device according to claim 5, wherein the information regarding the obstacle includes information regarding a sign indicating entry availability to the evacuation candidate area is possible, and information regarding an obstacle for preventing entry into the evacuation candidate area.

7. The vehicle control device according to claim 4, wherein the empty area includes land of a certain segment.

8. The vehicle control device according to claim 7, wherein the land of the certain segment includes a sidewalk adjacent to the road, a land of a building adjacent to the road, and a private land adjacent to the road.

9. The vehicle control device according to claim 3, further comprising:
an update unit configured to update the map information such that information of the evacuation area is included in the map information after the own vehicle evacuates to the evacuation area set by the evacuation area setting unit.

10. The vehicle control device according to claim 9, further comprising:
a communication unit configured to transmit the map information updated by the update unit to a vehicle management server that manages the own vehicle.

11. The vehicle control device according to claim 10, wherein the communication unit acquires map information managed by the vehicle management server.

12. A vehicle control method comprising:
recognizing external world information of a periphery of an own vehicle and detecting an evacuation candidate area for evacuating the own vehicle when passing by an oncoming vehicle;
determining availability of the detected evacuation candidate area; and
setting the evacuation candidate area determined as usable as an evacuation area.
